(19) United States
(12) Patent Application Publication
(10) Pub. No.: US 2024/0105925 A1
(43) Pub. Date: Mar. 28, 2024

(54) SOLID-STATE LITHIUM METAL BATTERY BASED ON IN-SITU POLYMERIZATION

(71) Applicant: YANGTZE DELTA REGION INSTITUTE OF UNIVERSITY OF ELECTRONIC SCIENCE AND TECHNOLOGY OF CHINA, HUZHOU, Huzhou (CN)

(72) Inventors: Ziqiang XU, Chengdu (CN); Mengqiang WU, Chengdu (CN); Zixuan FANG, Chengdu (CN); Xingwei ZHANG, Chengdu (CN)

(21) Appl. No.: 18/075,517

(22) Filed: Dec. 6, 2022

(30) Foreign Application Priority Data
Sep. 23, 2022 (CN) 202211167956.1

(51) Int. Cl. H01M 4/40; H01M 4/62; H01M 10/0565

(52) U.S. Cl. CPC H01M 4/405; H01M 4/622; H01M 10/0565; H01M 2004/027

(57) ABSTRACT

According to the application, a double interphase layer strategy with self-healing function is constructed at an interphase between an in-situ solid-state electrolyte and a lithium metal by the synergistic effect of double Lewis acids, a first protective layer inhibits a side reaction of the lithium metal and the in-situ solid-state electrolyte, and a second protective layer self-heals defects of the double interphase layer. The application solves the problem of unstable interface between electrode and electrolyte of in-situ solid-state lithium metal battery, and obtains lithium metal battery with high energy density, high coulombic efficiency and ultra-long cycling life.

### CROSS-REFERENCE TO RELATED APPLICATIONS

This application claims priority to Chinese Patent Application No. 202211167956.1, filed on Sep. 23, 2022, the contents of which are hereby incorporated by reference.

### TECHNICAL FIELD

The application belongs to the field of solid-state lithium metal battery preparation, and in particular to a solid-state lithium metal battery based on in-situ polymerization. A double interphase layer with self-healing function is constructed at an interface of in-situ polymerization solid-state electrolyte and lithium metal by utilizing the synergistic effect of double Lewis acids.

### BACKGROUND

As fossil energy is gradually faced with environmental problems such as exhaustion and greenhouse effect, it is particularly important to develop efficient and environmentally friendly new energy. The demand of new energy storage promotes the development of energy storage systems, and lithium rechargeable battery energy storage systems is extensively studied and applied because of its excellent cycle performance. Conventional liquid electrolyte lithium battery is limited in application because of its severe safety problems, and solid-state electrolyte can solve the leakage and easy combustion problems of conventional electrolyte. Therefore, developing solid-state electrolyte batteries with high energy density and ultra-long cycling performance will become a key of lithium rechargeable batteries in the future, and it is particularly crucial to further explore a stable solid-state battery system with high capacity, light weight or small volume.

The solid-state battery system mainly includes cathode, solid-state electrolytes and anode. When anode material with high theoretical specific capacity adapts to cathode material with high theoretical specific capacity, the battery system (such as lithium-sulfur battery and lithium-air battery) has higher energy density, and lithium metal becomes an excellent anode material with its high theoretical specific capacity, ultra-low electrochemical potential and low density. The solid-state electrolytes include inorganic solid-state electrolytes and solid-state polymer electrolytes. Although the inorganic solid-state electrolytes have high ionic conductivity and excellent cycling performance, its large-scale industrialization is restricted by its brittleness, difficulty in large-scale production and poor interface compatibility with electrodes. Solid-state polymer electrolytes are divided into in-situ polymer electrolyte and ex-situ solid-state polymer electrolyte. Because the in-situ solid-state polymer electrolyte has better interface compatibility with electrodes, and its simpler preparation process and environmentally friendly production process make in-situ solid polymer electrolyte have a better commercial application prospect.

The lithium metal battery adopting the in-situ solid-state polymer electrolyte has high energy density, which is the key technology of new generation lithium battery. However, the active nature of lithium metal and the instability of in-situ solid-state polymer electrolyte lead to an unstable interface between lithium metal and electrolyte. The initial solid-state electrolyte interphase (SEI) layer is loose, and is of low viscosity, which makes the SEI fall off easily and lose its activity to form dead lithium. At the same time, the newly exposed lithium metal continues to react with the in-situ solid-state electrolyte, resulting in the increasing interface impedance of the solid lithium metal battery system, severe lithium dendrite growth problems, low coulombic efficiency and short cycle life.

### SUMMARY

The objective of the present application is to provide a solid-state lithium metal battery based on in-situ polymerization, aiming at the problems of poor performance of solid-state electrolyte and poor interface stability between electrodes and electrolyte in the existing solid-state polymer lithium metal battery mentioned in the background technology. According to the application, a double interphase layer with self-healing function is constructed at the interface of in-situ polymerization solid-state electrolyte and lithium metal by the synergistic effect of double Lewis acids. First, a layer of solid-state electrolyte interphase (A-SEI) is formed in-situ as a first protective layer by adding solution containing a first Lewis acid on a surface of the lithium metal, and then a second Lewis acid is added into precursor solution of in-situ solid-state electrolyte to form a second protective layer on the surface of lithium metal. Meanwhile, Lewis acid inorganic additive has the effects of promoting lithium salt dissociation and allowing self-healing of SEI on the surface of lithium metal and consequently the cycle life of the in-situ polymerization solid-state lithium battery is effectively improved.

To achieve the above objective, a technical scheme adopted by the application is as follows.

A solid-state lithium metal battery based on in-situ polymerization includes following steps:
S1, pretreating a surface of lithium metal anode, and forming a layer of A-SEI in situ;
S1.1: adding the first Lewis acid into dimethyl sulfoxide, stirring for 2 hours, and uniformly mixing to obtain a mixed solution A, where a content of the first Lewis acid in the dimethyl sulfoxide is 0.1-0.5 wt. %;
S1.2, dropping the mixed solution A obtained in S1.1 onto the surface of lithium metal anode, with 20-50 μL of the mixed solution A per square centimeter of the lithium metal anode, tilting the lithium metal anode so that the lithium metal anode is completely covered by the mixed solution A, and keeping for 5-10 seconds;
S1.3, washing away residual mixed solution A on the lithium metal anode treated in S1.2 with tetrahydrofuran;
S1.4, drying the lithium metal anode treated in S1.3 in a glove box filled with argon for 1-3 days;
S2, preparing a solid-state electrolyte in-situ polymerization precursor solution;
S2.1, mixing 10-20 parts by mass of monomer and 2-8 parts by mass of polyfunctional crosslinker, stirring for 10 minutes and evenly mixing to obtain a mixed solution B;
S2.2, adding 1-5 parts by mass of lithium salt into the mixed solution B, stirring for 30 min and mixing evenly to obtain a mixed solution C and storing the mixed solution C at 2-8° C.;
S2.3, adding 1.56-3.96 parts by mass of the second Lewis acid into the mixed solution C, and stirring for 1 hour-3 hours to obtain a mixed solution D;
S2.4, adding 0.02-0.14 parts by mass of initiator and 62.90-85.24 parts by mass of plasticizer into the mixed solution D, and stirring for 30 min to obtain the solid-state electrolyte in-situ polymerization precursor solution; and
S3, laminating a cathode, a porous framework membrane and the lithium metal anode treated in S1 sequentially, packing with an aluminum-plastic film to obtain a cell with porous framework membrane; then, injecting the in-situ polymerization precursor solution prepared in S2 into the cell with porous framework membrane, with 20-50 μL per square centimeter, and carrying out an in-situ polymerization at 45-80° C. for 0.5 hour-8 hours to form a solid-state electrolyte, thus completing the preparation of lithium metal battery based on in-situ polymerization.

Optionally, the first Lewis acid is one of cupric chloride (CuCl₂), copper iodide (CuI₂), ferric chloride (FeCl₃), aluminum chloride (AlCl₃), aluminum bromide (AlBr₃) and aluminum iodide (AlI₃), and the second Lewis acid is one of cupric fluoride (CuF₂), aluminum fluoride (AlF₃) and ferric fluoride (FeF₃).

Optionally, the monomer is one of methyl methacrylate, ethyl methacrylate, propyl methacrylate, methyl acrylate, ethyl acrylate, vinyl ethylene carbonate and vinylene carbonate. The polyfunctional crosslinker is one of pentaerythritol tetraacrylate, oligopolyethylene glycol diacrylate, tripropylene glycol diacrylate, ethylene glycol dimethacrylate and trimethylolpropane triacrylate. The lithium salt is one of bistrifluoromethanesulfonimide lithium salt (LiTFSI), lithium bis(fluorosulfonyl)imide (LiFSI), lithium perchlorate (LiClO₄), lithium hexafluorophosphate (LiPF₆), lithium difluoro(oxalato)borate (LiDFOB) and lithium bis(oxalato)borate (LiBOB).

Optionally, the plasticizer is 0.8-4 mol/L lithium salt solution, solute of the lithium salt solution is one or two of LiTFSI, LiFSI, LiClO₄, LiPF₆, LiDFOB and LiBOB, and solvent is one or more of ethylene carbonate (EC), propylene carbonate (PC), 1,3-dioxolane (DOL), dimethoxyethane (DME), diethyl carbonate (DEC), and ethyl methyl carbonate (EMC). The initiator is one of azobisisobutyronitrile, 2,2′-azobisisovaleronitrile and 2,2″-azobis-(2,4-dimethylvaleronitrile).

Optionally, the porous framework membrane is one of lignocellulose membrane, electrospun polyimide membrane, glass fiber membrane, polyethylene separator, polypropylene membrane and electrospun polyvinylidene fluoride membrane, and a thickness of the porous framework membrane is less than 100 μm; an active material of the cathode is one of ferrous lithium phosphate, lithium cobaltate, nickel cobalt manganese ternary cathode and sulfur cathode.

Compared with the prior art, the application has following advantages.

The application provides a solid-state lithium metal battery based on in-situ polymerization, which adopts a double interphase layer with self-healing function at the interface between in-situ solid-state electrolyte and lithium metal under the synergistic action of double Lewis acids. Firstly, the solution containing the first Lewis acid is dropped on the surface of lithium metal, and the A-SEI containing LiCl or LiBr or LiI is formed in-situ as the first protective layer to inhibit the side reaction between lithium metal and in-situ solid-state electrolyte. Then, the second Lewis acid is added into the in-situ solid-state electrolyte polymerization precursor solution to continuously provide the raw materials for constructing lithium-containing alloy with high lithium ion diffusion and LiF-rich interphase layer with high modulus, and defects of the double interphase layer are self-healed to construct the second protective layer. According to the application, the problem of extremely unstable interface of in-situ solid-state lithium metal battery is solved, a compatible high-performance in-situ solid-state electrolyte is prepared, and a lithium metal battery with high energy density, high coulombic efficiency and ultra-long cycling life is obtained.

### BRIEF DESCRIPTION OF THE DRAWINGS

FIG. 1 is a schematic diagram of the principle of solid-state electrolyte systems in the lithium metal batteries obtained in embodiment 1 and blank 1, where M is copper (Cu), iron (Fe) and aluminum (Al), and X is chlorine (Cl), bromine (Br) and iodine (I).

FIG. 2 shows rate capability of lithium metal batteries of embodiment 1 and blank 1.

FIG. 3 shows charge-discharge long cycling performance of lithium metal batteries of embodiment 1 and blank 1 at 3 C rate.

FIG. 4 shows charge-discharge long cycling performance of lithium metal batteries of embodiment 4 and blank 2 at 3 C rate.

### DETAILED DESCRIPTION OF THE EMBODIMENTS

The present application will be further explained with reference to some comparative examples and embodiments below. It is worth noting that the specific embodiments described here are only for explaining the present application, but not for limiting the present application.

### Embodiment 1

A solid-state lithium metal battery based on in-situ polymerization includes following steps:
S1, pretreating a surface of lithium metal anode in a glove box filled with argon, and forming a layer of A-SEI (abbreviation of solid-state electrolyte interphase) in situ;
S1.1, adding AlI₃ into dimethyl sulfoxide, stirring for 2 hours and mixing evenly to obtain a mixed solution A, where the content of a first Lewis acid in the dimethyl sulfoxide is 0.12 wt. %;
S1.2, dropping the mixed solution A obtained in S1.1 onto the surface of lithium metal anode, with 25 μL of the mixed solution A per square centimeter of the lithium metal anode, tilting the lithium metal anode so that the lithium metal anode is completely covered by the mixed solution A, and keeping for 10 seconds;
S1.3, washing away residual mixed solution A on the lithium metal anode treated in S1.2 with 10 mL tetrahydrofuran;
S1.4, drying the lithium metal anode treated in S1.3 in the glove box filled with argon for 2 days for later use;
S2, preparing a solid-state electrolyte in-situ polymerization precursor solution;
S2.1, mixing 20 parts by mass of methyl methacrylate and 5 parts by mass of pentaerythritol tetraacrylate in the glove box with argon, stirring for 10 minutes and evenly mixing to obtain a mixed solution B;
S2.2, adding 3 parts by mass of LiFSI into the mixed solution B, stirring for 30 minutes, mixing evenly to obtain a mixed solution C and storing the mixed solution C at 2-8° C.;
S2.3, adding 1.56 parts by mass of AlF₃ into the mixed solution C, and stirring for 2 hours to obtain a mixed solution D;
S2.4, adding 0.05 mass part of azobisisobutyronitrile initiator and 70.39 mass part of plasticizer (1 mol/L lithium salt solution, LiFSI as solute, mixed solvent of 1,3-dioxolane (DOL) and dimethoxyethane (DME) with volume ratio of 1:1 as solvent) into the mixed solution D, and stirring for 30 minutes to obtain the solid-state electrolyte in-situ polymerization precursor solution containing Lewis acid additive;
S3, respectively welding nickel and aluminum tabs on the lithium metal anode treated in S1 and a ferrous lithium phosphate cathode, then laminating the ferrous lithium phosphate cathode, an electrospun polyimide membrane and the lithium metal anode treated in S1 sequentially, packaging with an aluminum-plastic film, and reserving a liquid injection port to obtain a cell with porous framework membrane; and
S4, injecting the in-situ polymerization precursor solution prepared in S2 into the cell with porous framework membrane, with 40 μL of the in-situ polymerization precursor solution per square centimeter of the cell, then vacuumizing, sealing, standing for 12 hours, and then polymerizing in-situ at 65° C. for 2 hours to form solid-state electrolyte, thus finishing preparing lithium metal battery based on in-situ polymerization.

The lithium metal battery obtained in embodiment 1 is activated for 3 cycles at 0.1 C rate and then subjected to long cycling at 3 C rate on LAND charge-discharge instrument, with an average coulombic efficiency of 99.97% and a cycle life of 345 cycles.

### Embodiment 2

Compared with embodiment 1, this embodiment is different in that the first Lewis acid is replaced by AlCl₃, and other steps are exactly the same as embodiment 1.

The lithium metal battery obtained in embodiment 2 is activated for 3 cycles at 0.1 C rate and then subjected to long cycling at 3 C rate on LAND charge-discharge instrument, with an average coulombic efficiency of 99.98% and a cycle life of 370 cycles.

### Embodiment 3

Compared with embodiment 1, this embodiment is different in that the second Lewis acid is replaced by CuF₂, and other steps are exactly the same as embodiment 1.

The lithium metal battery obtained in embodiment 3 is activated for 3 cycles at 0.1 C rate and then subjected to long cycling at 3 C rate on LAND charge-discharge instrument, with an average coulombic efficiency of 99.92% and a cycle life of 274 cycles.

### Embodiment 4

A solid-state lithium metal battery based on in-situ polymerization includes following steps:
S1, pretreating a surface of lithium metal anode in a glove box filled with argon, and forming a layer of A-SEI in situ;
S1.1, adding FeCl₃ into dimethyl sulfoxide, stirring for 2 hours and mixing evenly to obtain a mixed solution A, where the content of the first Lewis acid in the dimethyl sulfoxide is 0.12 wt. %;
S1.2, dropping the mixed solution A obtained in S1.1 onto the surface of lithium metal anode, with 25 μL of the mixed solution A per square centimeter of the lithium metal anode, tilting the lithium metal anode so that the lithium metal anode is completely covered by the mixed solution A, and keeping for 10 seconds;
S1.3, washing away residual mixed solution A on the lithium metal anode treated in S1.2 with 10 mL tetrahydrofuran;
S1.4, drying the lithium metal anode treated in S1.3 in the glove box filled with argon for 2 days for later use;
S2, preparing a solid-state electrolyte in-situ polymerization precursor solution;
S2.1, mixing 20 parts by mass of vinylene carbonate and 5 parts by mass of pentaerythritol tetraacrylate in the glove box with argon, stirring for 10 minutes and evenly mixing to obtain a mixed solution B;
S2.2, adding 3 parts by mass of LiTFSI into the mixed solution B, stirring for 30 minutes, mixing evenly to obtain a mixed solution C and storing the mixed solution C at 2-8° C.;
S2.3, adding 1.56 parts by mass of AlF₃ into the mixed solution C, and stirring for 2 hours to obtain a mixed solution D;
S2.4, adding 0.05 mass part of azobisisobutyronitrile initiator and 70.39 mass part of plasticizer (1 mol/L lithium salt solution, LiTFSI as solute, mixed solvent of 1,3-dioxolane (DOL) and dimethoxyethane (DME) with volume ratio of 1:1 as solvent) into the mixed solution D, and stirring for 30 minutes to obtain the solid-state electrolyte in-situ polymerization precursor solution containing Lewis acid additive;
S3, respectively welding nickel and aluminum tabs on the lithium metal anode treated in S1 and a ferrous lithium phosphate cathode, then laminating the ferrous lithium phosphate cathode, lignocellulose membrane and the lithium metal anode treated in S1 sequentially, packaging with an aluminum-plastic film, and reserving a liquid injection port to obtain a cell with porous framework membrane; and
S4, injecting the in-situ polymerization precursor solution prepared in S2 into the cell with porous framework membrane, with 40 μL of the in-situ polymerization precursor solution per square centimeter of the cell, then vacuumizing, sealing, standing for 12 hours, and then polymerizing in-situ at 70° C. for 5 hours to form solid-state electrolyte, thus finishing preparing lithium metal battery based on in-situ polymerization.

The lithium metal battery obtained in embodiment 4 is activated for 3 cycles at 0.1 C rate and then subjected to long cycling at 3 C rate on LAND charge-discharge instrument, with an average coulombic efficiency of 99.89% and a cycle life of 234 cycles.

### Embodiment 5

A solid-state lithium metal battery based on in-situ polymerization includes following steps:
S1, pretreating a surface of lithium metal anode in a glove box filled with argon, and forming a layer of A-SEI in situ;
S1.1, adding AlBr₃ into dimethyl sulfoxide, stirring for 2 hours and mixing evenly to obtain a mixed solution A, where the content of the first Lewis acid in the dimethyl sulfoxide is 0.4 wt. %;
S1.2, dropping the mixed solution A obtained in S1.1 onto the surface of lithium metal anode, with 25 μL of the mixed solution A per square centimeter of the lithium metal anode, tilting the lithium metal anode so that the lithium metal anode is completely covered by the mixed solution A, and keeping for 10 seconds;
S1.3, washing away residual mixed solution A on the lithium metal anode treated in S1.2 with 10 mL tetrahydrofuran;
S1.4, drying the lithium metal anode treated in S1.3 in the glove box filled with argon for 2 days for later use;
S2, preparing a solid-state electrolyte in-situ polymerization precursor solution;
S2.1, mixing 20 parts by mass of methyl methacrylate and 5 parts by mass of oligopolyethylene glycol diacrylate in the glove box with argon, stirring for 10 minutes and evenly mixing to obtain a mixed solution B;
S2.2, adding 3 parts by mass of LiTFSI into the mixed solution B, stirring for 30 minutes, mixing evenly to obtain a mixed solution C and storing the mixed solution C at 2-8° C.;
S2.3, adding 1.56 parts by mass of FeF₃ into the mixed solution C, and stirring for 2 hours to obtain a mixed solution D;
S2.4, adding 0.05 mass part of azobisisobutyronitrile initiator and 70.39 mass part of plasticizer (1 mol/L lithium salt solution, LiTFSI as solute, mixed solvent of 1,3-dioxolane (DOL) and dimethoxyethane (DME) with volume ratio of 1:1 as solvent) into the mixed solution D, and stirring for 30 minutes to obtain the solid-state electrolyte in-situ polymerization precursor solution containing Lewis acid additive;
S3, respectively welding nickel and aluminum tabs on the lithium metal anode treated in S1 and a sulfur cathode, then laminating the sulfur cathode, an electrospun polyimide membrane and the lithium metal anode treated in S1 sequentially, packaging with an aluminum-plastic film, and reserving a liquid injection port to obtain a cell with porous framework membrane; and
S4, injecting the in-situ polymerization precursor solution prepared in S2 into the cell with porous framework membrane, with 40 μL of the in-situ polymerization precursor solution per square centimeter of the cell, then vacuumizing, sealing, standing for 12 hours, and then polymerizing in-situ at 70° C. for 5 hours to form solid-state electrolyte, thus finishing preparing lithium metal battery based on in-situ polymerization.

The lithium metal battery obtained in embodiment 5 is activated for 3 cycles at 0.1 C rate and then subjected to long cycling at 1 C rate on LAND charge-discharge instrument, with an average coulombic efficiency of 99.94% and a cycle life of 286 cycles.

Blank 1

Blank 1 is set to illustrate an optimization effect of the double interphase layer strategy of the present application on a solid-state lithium metal battery system.

In blank 1, in S1, when the lithium metal anode is pretreated, the first Lewis acid is not added, and only dimethyl sulfoxide is used for treatment; in S2, in preparing the polymerization precursor solution, the second Lewis acid is not added. Other steps are exactly the same as those in embodiment 1.

The lithium metal battery obtained in blank 1 is activated for 3 cycles at 0.1 C rate and then subjected to long cycling at 3 C rate on LAND charge-discharge instrument, with an average coulombic efficiency of 99.06% and a cycle life of 110 cycles.

Blank 2

Blank 2 is set to demonstrate the different effects of double interphase layer strategy on solid-state lithium metal battery system compared with single A-SEI.

In blank 2, the second Lewis acid is not added in preparing the polymerization precursor solution in S2. Other steps are exactly the same as in embodiment 4.

The lithium metal battery obtained in blank 2 is activated for 3 cycles at 0.1 C rate and then subjected to long cycling at 3 C rate on LAND charge-discharge instrument, with an average coulombic efficiency of 99.43% and a cycle life of 168 cycles.

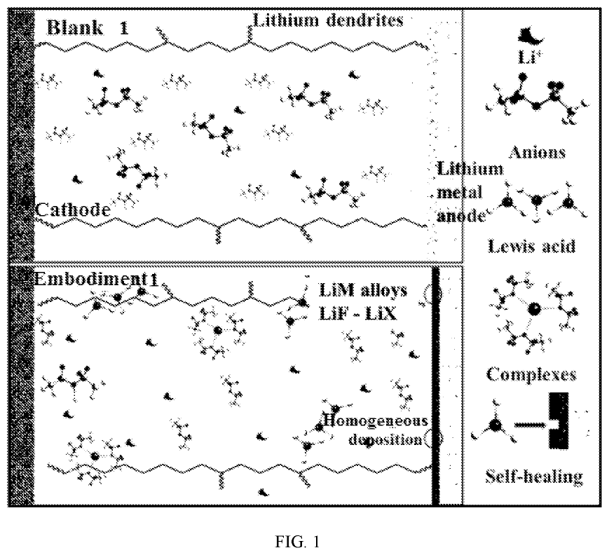

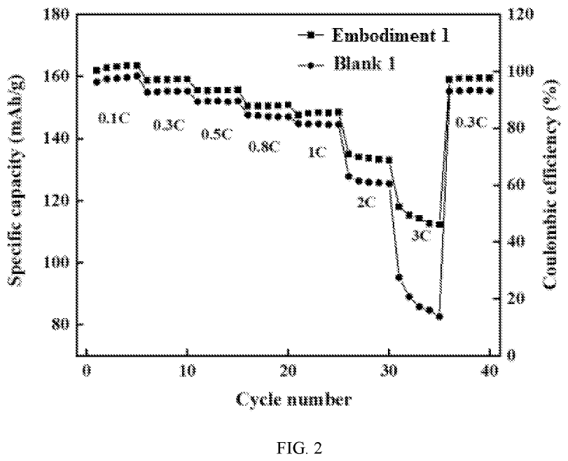

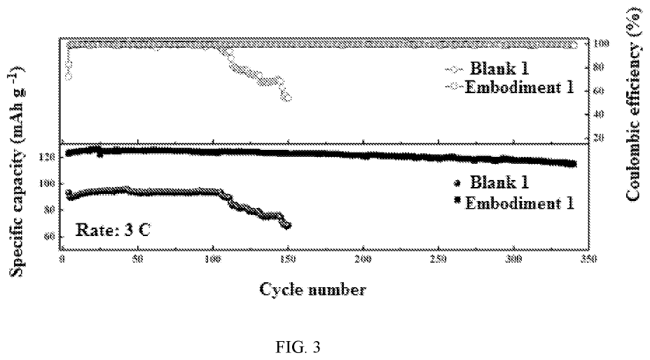

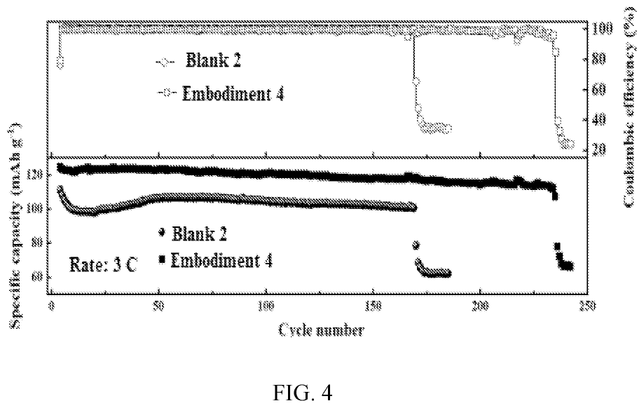

FIG. 1 is a schematic diagram of the principle of the solid-state electrolyte systems in the lithium metal batteries obtained in embodiment 1 and blank 1 and it is suggested that the double interphase layer strategy induces homogeneous deposition of lithium ions, effectively inhibits lithium dendrites to grow, and greatly improves the interface between lithium metal and in-situ solid-state electrolyte. FIG. 2 shows the rate performance of the lithium metal batteries of embodiment 1 and blank 1 and it is suggested that the double interphase layer has higher lithium ion diffusion ability, and still maintains a high discharge specific capacity at high rate. At the same time, the double interphase layer strategy also greatly improves the cycle life of the in-situ solid-state lithium metal batteries, as shown in FIG. 3. FIG. 4 shows the long cycling performance of the lithium metal batteries of embodiment 4 and blank 2 at 3 C rate and it is suggested that the single A-SEI layer is easily broken and has no self-healing ability. Meanwhile, the double interphase layer strategy optimizes the electrode electrolyte interface of the lithium metal batteries and improves the energy density and cycle life of the lithium metal batteries.

What is claimed is:

1. A solid-state lithium metal battery based on in-situ polymerization, comprising:
S1, pretreating a surface of lithium metal anode:
S1.1, adding a first Lewis acid into dimethyl sulfoxide, stirring and uniformly mixing to obtain a mixed solution A, wherein a content of the first Lewis acid in the dimethyl sulfoxide is 0.1-0.5 weight percent (wt. %);
S1.2, dropping the mixed solution A obtained in the S1.1 onto the surface of lithium metal anode, with 20-50 microliters (μL) of the mixed solution A per square centimeters of the lithium metal anode, and keeping for 5-10 seconds;
S1.3, washing away residual mixed solution A on the lithium metal anode treated in S1.2 with tetrahydrofuran;
S2, preparing a solid-state electrolyte in-situ polymerization precursor solution;
S2.1, mixing 10-20 parts by mass of monomer and 2-8 parts by mass of polyfunctional crosslinker, stirring and evenly mixing to obtain a mixed solution B;
S2.2, adding 1-5 parts by mass of lithium salt into the mixed solution B, stirring and mixing evenly to obtain a mixed solution C and storing the mixed solution C at 2-8° C.;
S2.3, adding 1.56-3.96 parts by mass of a second Lewis acid into the mixed solution C, and stirring to obtain a mixed solution D;
S2.4, adding 0.02-0.14 parts by mass of initiator and 62.90-85.24 parts by mass of plasticizer into the mixed solution D, and stirring to obtain the solid-state electrolyte in-situ polymerization precursor solution; and
S3, laminating a cathode, a porous framework membrane and the lithium metal anode treated in the S1 sequentially, packing with an aluminum-plastic film to obtain a cell with porous framework membrane; then injecting the in-situ polymerization precursor solution prepared in the S2 into the cell with porous framework membrane with 20-50 μL per square centimeters, and carrying out an in-situ polymerization at 45-80° C. for a duration of 0.5 hour-8 hours to form the solid-state electrolyte to finish preparing the lithium metal battery based on in-situ polymerization.

2. The solid-state lithium metal battery based on in-situ polymerization according to claim 1, wherein the first Lewis acid is one of cupric chloride (CuCl₂), copper iodide (CuI₂), ferric chloride (FeCl₃), aluminum chlorid e (AlCl₃), aluminum bromide (AlBr₃) and aluminum iodide (AlI₃), and the second Lewis acid is one of cupric fluoride (CuF₂), aluminum fluoride (AlF₃) and ferric fluoride (FeF₃).

3. The solid-state lithium metal battery based on in-situ polymerization according to claim 1, wherein the monomer is one of methyl methacrylate, ethyl methacrylate, propyl methacrylate, methyl acrylate, ethyl acrylate, vinyl ethylene carbonate and vinylene carbonate; the polyfunctional crosslinker is one of pentaerythritol tetraacrylate, oligopolyethylene glycol diacrylate, tripropylene glycol diacrylate, ethylene glycol dimethacrylate and trimethylolpropane triacrylate; and the lithium salt is one of bistrifluoromethanesulfonimide lithium salt (LiTFSI), lithium bis(fluorosulfonyl)imide (LiFSI), lithium perchlorate (LiClO₄), lithium hexafluorophosphate (LiPF₆), lithium difluoro(oxalato)borate (LiDFOB) and lithium bis(oxalato)borate (LiBOB).

4. The solid-state lithium metal battery based on in-situ polymerization according to claim 1, wherein the plasticizer is 0.8-4 mole/liter (mol/L) lithium salt solution, solute of the lithium salt solution is one or two of bistrifluoromethanesulfonimide lithium salt (LiTFSI), lithium bis(fluorosulfonyl)imide (LiFSI), lithium perchlorate (LiClO₄), lithium hexafluorophosphate (LiPF₆), lithium difluoro(oxalato)borate (LiDFOB) and lithium bis(oxalato)borate (LiBOB), and solvent is one or more of ethylene carbonate, propylene carbonate, 1,3-dioxolane, dimethoxyethane, diethyl carbonate, and ethyl methyl carbonate; the initiator is one of azobisisobutyronitrile, 2,2′-azobisisovaleronitrile and 2,2″-azobis-(2,4-dimethylvaleronitrile).

5. The solid-state lithium metal battery based on in-situ polymerization according to claim 1, wherein the porous framework membrane is one of lignocellulose membrane, electrospun polyimide membrane, glass fiber membrane, polyethylene separator, polypropylene separator and electrospun polyvinylidene fluoride membrane, and a thickness of the porous framework membrane is less than 100 μm; and an active material of the cathode is one of ferrous lithium phosphate, lithium cobaltate, nickel cobalt manganese ternary cathode and sulfur cathode.
